(19) United States
(12) Patent Application Publication
(10) Pub. No.: US 2018/0235186 A1
(43) Pub. Date: Aug. 23, 2018

(54) Apparatus and method for the monitoring of caged birds

(71) Applicant: Jeffrey N. Masters, Melrose, MA (US)

(72) Inventor: Jeffrey N. Masters, Melrose, MA (US)

(73) Assignee: Jeffrey N. Masters, Melrose, MA (US)

(21) Appl. No.: 15/439,732

(22) Filed: Feb. 22, 2017

(51) Int. Cl. A01K 45/00; G01H 11/08; G01K 7/02; G01J 1/42; G01G 19/52; A01K 31/06; A01K 31/12; H04R 1/02; H04R 1/04; H04N 7/18

(52) U.S. Cl. CPC A01K 45/00; G01H 11/08; G01K 7/02; G01J 1/4204; H04N 7/183; A01K 31/06; A01K 31/12; H04R 1/028; H04R 1/04; G01G 19/52

(57) ABSTRACT

A health monitoring system for caged birds is described. An enclosure containing sensors and associated circuitry mounts to the outside of a bird cage with a perch protruding into the cage.

The sensors included in the present embodiment are a strain gauge load cell for bird weight measuring, a temperature sensor, and an ambient light sensor. The load cell is used with a perch such that the bird's weight can be measured whenever they alight upon the perch. Also included is a piezoelectric sensor to measure vibration data from the cage itself, which is used as a proxy for the bird's activity level. Associated circuitry and software processes and transmits this data to an internet-hosted server. The user can access this information to track a caged bird's weight, activity level, and environmental conditions over time.

### FIELD OF THE INVENTION

The present invention relates to monitoring the health and behavior of caged birds and their environment, and more particularly, an apparatus and system for determining a bird's weight and activity level, as well as the ambient temperature and amount of light in the bird's cage, and recording this information over time. This information is valuable to avian researchers and pet bird owners.

### BACKGROUND OF THE INVENTION

Birds held in captivity are commonly prey animals; and as such, strive to hide signs of illness and injury. By the time a bird shows obvious signs of an illness or injury, it has often progressed a great deal from the onset of the condition. Frequent monitoring of the bird and its environment can enable caretakers to aid in identifying any problems the bird has in advance of observable symptoms. The present invention allows for constant monitoring without any user intervention.

A common proxy used for health in birds is their weight. Sudden weight loss or gain can be indicative of a wide variety of disease or other physiological problems.

Birds are ordinarily only observed by their caretakers for a limited part of the day, and it can be difficult to determine if their level of activity has significantly increased or, more worryingly, decreased compared to normal.

A bird's environment, namely temperature and exposure to light, can affect their behavior and overall health.

### DESCRIPTION OF RELATED ART

Since a bird's weight is a common health metric, common stand-alone scales are available for sale with bird perches attached. These products are used by coaxing a bird to perch upon the device, which is then read, to obtain the bird's weight. Then, the bird's weight can be compared to previous measurements of the same bird to make a determination as to the bird's health.

Bird perches with built-in recording scales are known in the art. Specifically, U.S. Pat. No. 4,811,694 discloses a Bird feeder with scale, where a bird is drawn to a perch by the lure of food. The perch then lowers with the bird's weight against a spring, and the device measures the bird's weight by amount of spring displacement. The device can be set to trigger an alarm to alert the user to manually record the weight, or the mechanism can be attached to a strip-chart recorder.

The present invention is fundamentally different than the prior art as it is designed to be mounted to a bird cage and perform measurements, rather than be a stand-alone device with a feeder for poultry. The present invention also provides key improvements over this device. One, by the use of a strain gauge load cell rather than a spring displacement mechanism to measure the bird's weight, the perch upon which the bird alights will move imperceptibly to the bird so as to not disturb it. Two, by providing environmental measurements of the bird cage by means of a piezo vibration sensor, a light sensor, and a temperature sensor, it gives previously-unavailable context to the weight measurements. Three, by means of radio transmission to an Internet-connected server, it allows for all of these measurements to be presented to the user at an interface convenient to them.

### BRIEF DESCRIPTION OF THE DRAWINGS

FIG. 1 shows the present invention installed in a cage with a bird sitting on perch 100.

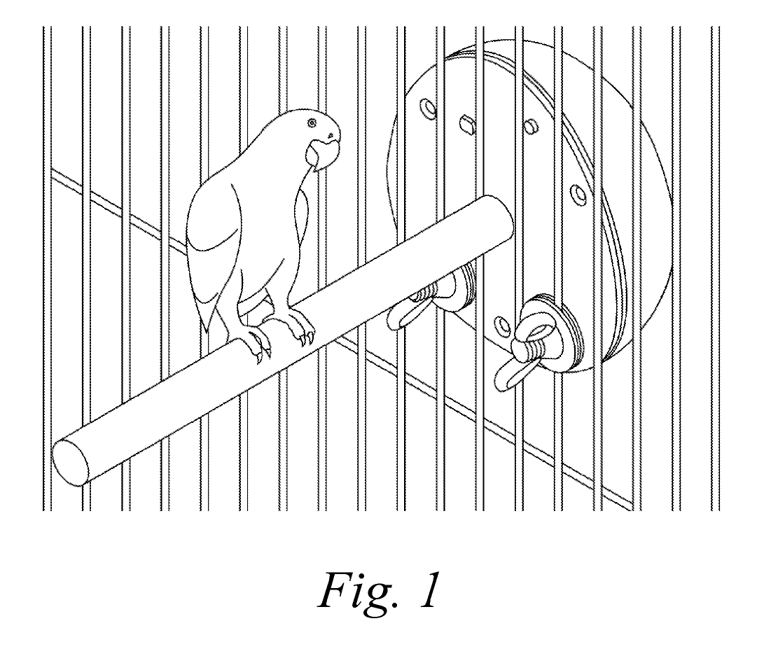

FIG. 2 shows a perspective view of the present invention.

FIG. 3 shows an exploded rear perspective view of the present invention.

FIG. 4 shows an elevation view of the present invention without back shell 102.

FIG. 5 shows a block diagram of the bird health monitoring system of the present invention.

### DETAILED DESCRIPTION

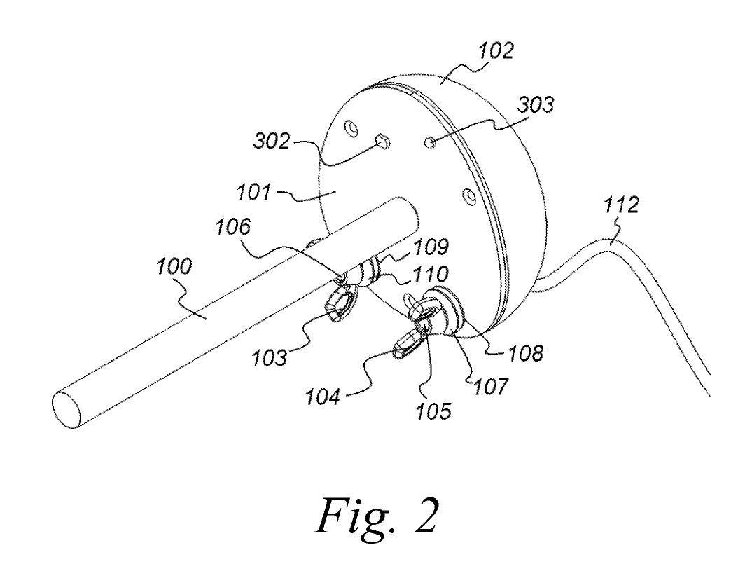

Referring now to the drawings, and primarily FIG. 2, the present invention comprises a bird perch 100 protruding from an enclosure comprising of mounting plate 101 and back shell 102. The mounting plate 101 has in addition protruding from it parallel to perch 100 two threaded rods 105 and 106 with which to securely fasten the enclosure to a bird cage by means of washers 107, 108, 109, 110 and wing nuts 103 and 104. In other embodiments, the enclosure may attach to the bird cage via a hinged clip or other mechanism.

Electrical wire 112 passes through a hole in the back shell 102 to power the device with electricity.

Light sensor 302 and temperature sensor 303 are affixed to a mounting plate 101 such that light and temperature readings, respectively, may be taken of the cage's environment.

In the present embodiment, light sensor 302 is a photoresistor of a type known in the art, and temperature sensor 303 is a thermocouple of a type known in the art. Both sensors 302 and 303 generate signals correlated to the parameters they intend to measure and transmit those signals to microcontroller 200 for processing.

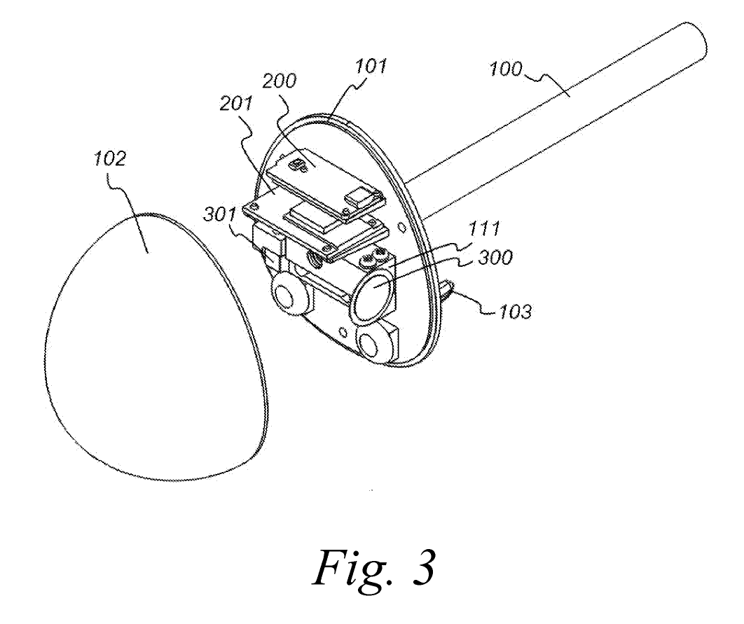

FIG. 3 is an exploded rear perspective view with back shell 102 removed from mounting plate 101. Microcontroller 200 is mounted on mounting plate 101 and contains within it a microprocessor and related circuitry to receive, process and perform calculations on, and transmit signals. Wireless radio 201 is mounted on mounting plate 101 and contains within it a wireless radio to connect to common wireless internet networks, e.g. WiFi, and related circuitry to receive, process and perform calculations on, and transmit signals. There are also embodiments where the wireless radio and the microprocessor occupy the same printed circuit board.

Piezo sensor 300 is shown affixed to mounting block 111 such that it is able to sense vibrations throughout the device and, through mounting to a bird cage, throughout the cage. The signal generated by piezo sensor 300 is sent to microcontroller 200 for processing, where the signal can be interpreted to ascertain events in the cage corresponding to a bird's movement about the cage. By tracking the number of these events over time, microcontroller 200 can determine how active the bird is.

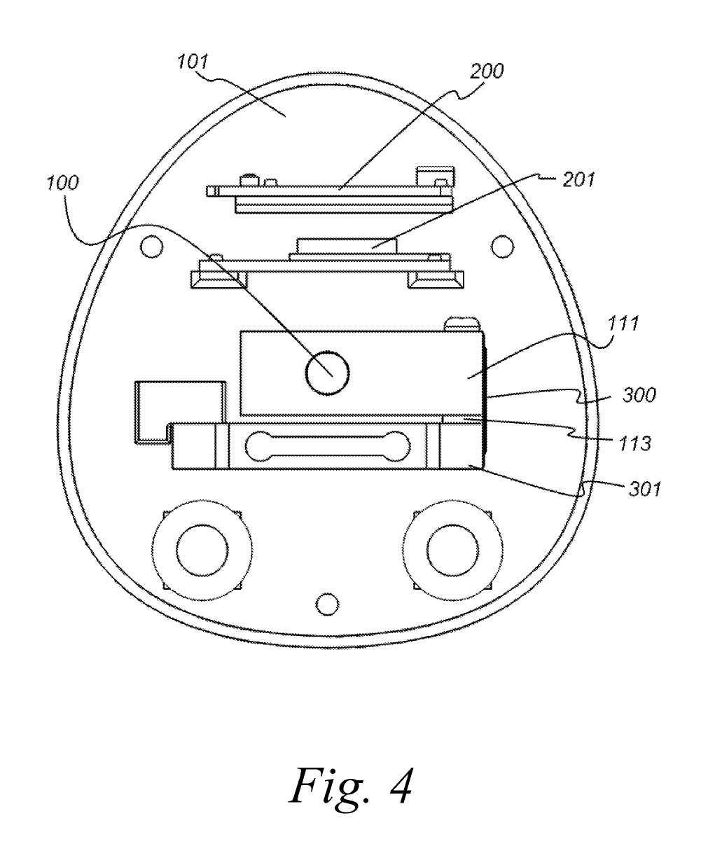

FIG. 4 is an elevated rear view of mounting plate 101 with back shell 102 not visible. In the present embodiment of the invention, load cell 301 is of a strain gauge type commonly known in the art. By affixing load cell 301 to mounting plate 101 and to bird perch 100 via mounting block 111, and being vertically offset by spacer 113, the electrical signal generated by load cell 301 is correlated to any forces exerted by and on the perch 100. This electrical signal is sent to microcontroller 200 and processed in such fashion as to determine the weight of any bird upon the perch, or to determine the lack thereof, by considering the tare weight of the perch 100.

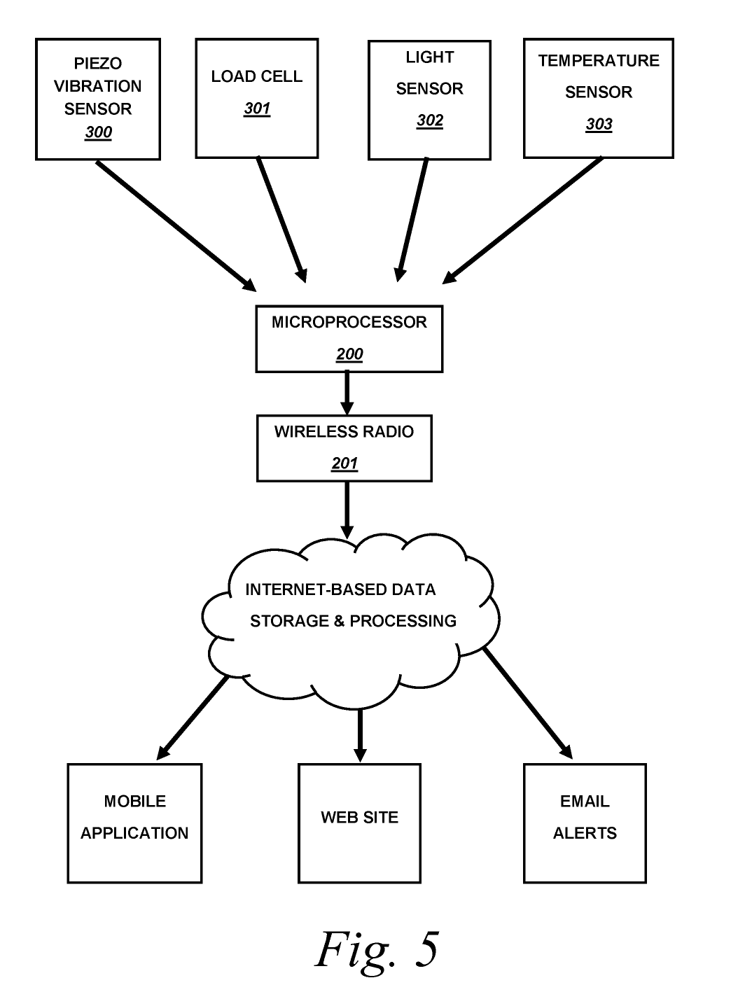

FIG. 5 is a block diagram showing the process of operation of the present invention. Seismic events in the cage from the piezo vibration sensor 300, weight from load cell 301, light levels from light sensor 302, and temperature from temperature sensor 303 are transmitted to microcontroller 200. It is to be understood that in addition to the sensors in the present embodiment that other sensors may be used as well. Microcontroller 200 processes these signals using techniques known in the art and sends them to wireless radio 201, which transmits the data to an internet-based server for storage and further processing, before being presented to the user via a mobile-device application or a web site. In addition, the internet-based server is able to detect certain event conditions and alert the user to them over email, such as a low bird weight reading or a low temperature reading.

I claim:

1. An apparatus for monitoring a caged bird, comprising a weighing mechanism wherein the weighing mechanism is attachable to a bird cage, and a perch wherein any weight applied to the perch is measurable.

2. The apparatus of claim 1 wherein said apparatus also includes an ambient temperature sensor.

3. The apparatus of claim 1 wherein said apparatus also includes an ambient light sensor.

4. The apparatus of claim 1 wherein said apparatus also includes a piezo vibration sensor.

5. The apparatus of claim 1 wherein said apparatus also includes a humidity sensor.

6. The apparatus of claim 1 wherein said apparatus also includes a microphone.

7. The apparatus of claim 1 wherein said apparatus also includes a still or video camera.

8. A method of monitoring a caged bird, comprising using a weighing mechanism to weigh a caged bird, wherein the weighing mechanism is attached to a bird cage; and recording the weight over a period of time.

9. A method of monitoring a caged bird, comprising a vibration sensor to detect vibrations of the cage, wherein the vibration sensor is attached to the bird cage; and recording the vibrations over time.
